(19) United States
(12) Patent Application Publication
(10) Pub. No.: US 2011/0291374 A1
(43) Pub. Date: Dec. 1, 2011

(54) Wheeled Crutch

(76) Inventor: Robert Kerley, Dallas, TX (US)

(21) Appl. No.: 12/791,459

(22) Filed: Jun. 1, 2010

(51) Int. Cl. A61H 3/04; A61H 3/02; B62M 1/00

(52) U.S. Cl. 280/87.041; 482/68

(57) ABSTRACT

The present invention is directed towards a wheeled crutch that supports an injured human lower limb with the injured limb extended towards the front of the user. The wheeled crutch comprises a seat attached to a seat support, and a wheeled base with at least three legs. A lower limb support and foot rest allow the user to rehabilitate the injured lower limb while remaining ambulatory.

### BACKGROUND OF THE INVENTION

Many different human activities are known to cause various types of injuries to the human lower limbs. When the severity of a lower limb injury reaches a certain threshold, the injured person desires to keep the injured limb as motionless as possible, due to one or a combination of doctor's orders to keep the limb still, or an effort on the part of the injured person to avoid pain associated with limb motion. However, the injured person also desires to remain ambulatory in order to avoid as many disruptions in their day to day life as possible.

The most basic device that is known in the art to allow a person with one injured lower limb and one functional lower limb to remain ambulatory is the underarm crutch. An underarm crutch is a rigid member that the injured person uses to support a portion of their weight while walking. It has an underarm pad that engages with the underarm of the person using the crutch, and a handle approximately parallel with the underarm pad that the injured person grasps while using the crutch. Typically, two underarm crutches are used by a person with an injured lower limb. Underarm crutches cause most users substantial discomfort when they are used for extended periods of time, and only allow users to move around much more slowly than they would with two healthy lower limbs. Forearm crutches are similar in construction and function, except they attach to the user's forearm instead of the underarm when in use.

A wheeled crutch is disclosed in U.S. Pat. No. 4,867,188. As depicted in FIG. 3 therein, the user 32 of the wheeled crutch 10 rests the knee 36 of the injured lower limb 34 on a knee rest 12, which itself is attached to four wheels 24. The foot of the injured limb 34 extends behind the user 32 of the wheeled crutch 10. While the wheeled crutch disclosed therein may be useful for injuries to the lower limb occurring below the knee, the device would be useless for lower limb injuries to the knee and above.

A need exists for an improved device that allows humans with one injured lower limb and one functional lower limb to remain ambulatory.

### SUMMARY OF THE INVENTION

The present invention is thus directed towards a wheeled crutch that can be used by humans with injuries to one lower limb, regardless of where the injury is located on the lower limb. It is particularly useful for knee injuries, but can also be used for thigh, lower leg, ankle and foot injuries.

In one embodiment, the wheeled crutch generally comprises a seat attached to a seat support base adapted to engage one human buttock when the human sits on the seat, and a wheeled base which comprises at least 3 legs, with one wheel attached to each leg. The wheeled crutch also comprises a lower limb support attached to and located between two of the legs, and adapted to support a human lower limb which is extended frontward from a user of said wheeled crutch, and a foot rest attached the same two legs at an end of the lower limb support opposite the support base.

In one embodiment, the legs of the wheeled crutch are each connected to the support base by a hinge. In another embodiment, the wheeled crutch seat is height adjustable relative to the support base. In still another embodiment, the lower limb support comprises a flexible mesh support. In yet another embodiment, the foot rest comprises a flexible strap.

In one embodiment, the wheeled crutch further comprises at least one hinge attached to each leg and adapted to restrict outward movement of the legs to a predetermined distance. In another embodiment, the legs are length adjustable.

In one embodiment, the wheeled further comprises a hand brake. In another embodiment, at least one of the wheels can swivel.

### BRIEF DESCRIPTION OF THE DRAWINGS

A more complete understanding of the method of the present invention may be had by reference to the following detailed description when taken in conjunction with the accompanying drawings, wherein:

FIG. 1 is a perspective view of one embodiment of the present invention in use;

FIG. 2 is a perspective view of one embodiment of the present invention;

FIG. 3 is a perspective view of one embodiment of the present invention collapsed for storage or transport;

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

The present invention is directed towards a wheeled crutch that can be used by a person with one injured lower limb and one functional lower limb. When referring to a person herein, the term “lower limb” will refer to the portion of the human body which is typically colloquially referred to with respect to humans as the “leg,” which runs from the hip to the foot, inclusive. The human leg is referred to by the term “lower limb” in order to distinguish it from the structural term “leg” which is used to describe certain portions of the inventive apparatus described and claimed herein. Thus, the wheeled crutch of the present invention comprises several novel features that allow the user to remain ambulatory regardless of the location of the lower limb injury, and without the discomfort associated with previous crutches.

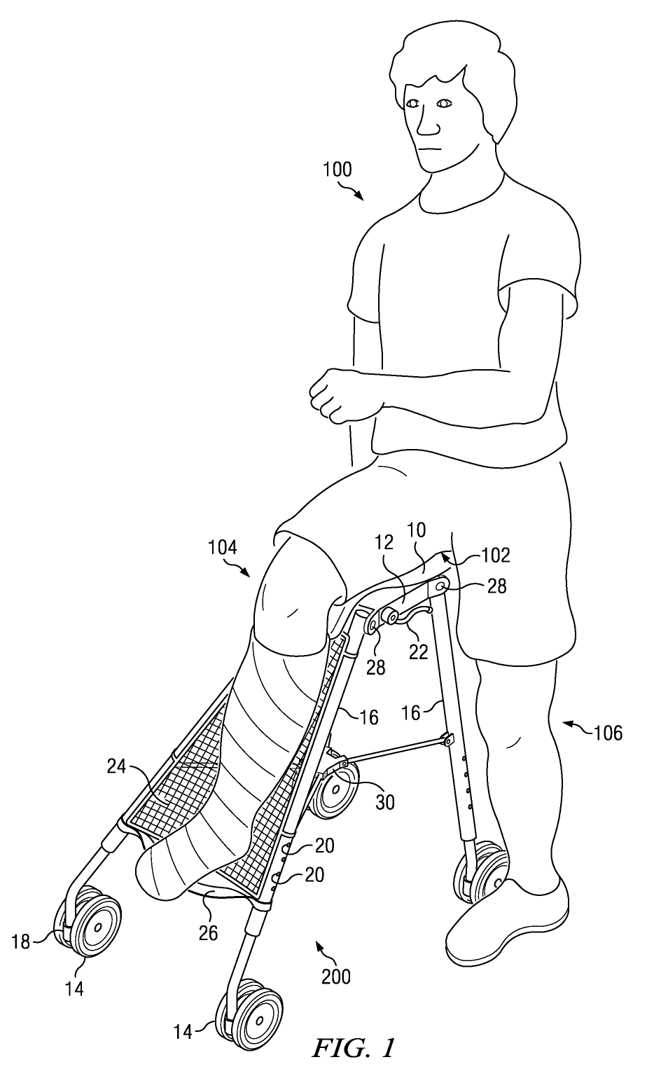

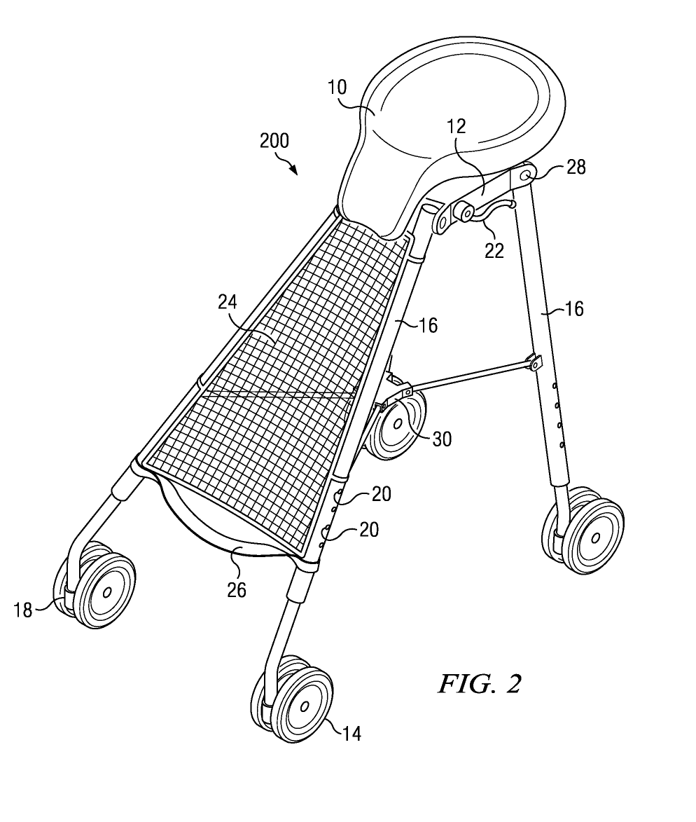

One embodiment of the present invention is depicted in use by an injured person 100 in FIG. 1, and alone, apart from the user in FIG. 2. In one embodiment of the present invention, the wheeled crutch 200 comprises a seat 10 adapted to receive and support one human buttock 102 when the user 100 sits or applies a substantial portion of the user's body weight on the seat 10 through the buttock. When the apparatus of the present invention is in use, the user 100 will rest the buttock 102 associated with the injured lower limb 104 on the seat. Preferably, as depicted in FIG. 2, the front portion of the seat 10 is concave and adapted to engage and support the injured lower limb 104 of the user 100.

In one embodiment, the seat 10 is attached to a seat support base 12, and supported by a wheeled base. In the embodiment depicted in FIGS. 1 through 3, the wheeled base comprises four wheels 14 attached for four support members 16, which are referred to herein as “legs” (which are distinguished from the human “lower limb” as described above). Although not depicted, the wheeled base could comprise as few as three wheels, or as many wheels as are practicable under the construction of the particular embodiment of the wheeled crutch, and which do not appreciably interfere with the ability of the functional lower limb 106 to propel the user of the wheeled crutch 200. The wheels 14 can comprise casters, or other wheels known in the art. In another embodiment, at least one of the wheels is capable of swiveling to allow the user to maneuver the wheeled crutch in multiple directions. A wheel can be given swivel capability by attaching it to the support leg by a swivel joint 18, or other methods known in the art.

As depicted in FIGS. 1 and 2, in one embodiment, the support legs 16 extend a distance from just below the seat 10 to the wheels 14. However, in other embodiments, the seat could be supported by its own support member or members (not shown), which is attached to the support base 12, which in turn is attached to the legs of the wheeled base. In these embodiments, the legs 16 would extend a distance from the seat support base 12 to the wheels 14. In another embodiment, the height of the seat (or, the distance between the seat and the seat support base) is adjustable relative to the support base 12 by means of a telescoping support member, or other means known in the art.

In the embodiment depicted in FIGS. 1 and 2, the lengths of the legs 16 are adjustable. As depicted therein, the lower section of the legs 16 are telescoping, and can be fixed in place by aligning sets of alignment holes 20 provided in the upper and lower sections of the leg. In other embodiments, the telescoping legs can be fixed in place using other means, such as a pressure coupler, a ratchet locking mechanism, or a hydraulic actuator, as can be determined by those skilled in the art.

Adjustable legs 16 allow the user to customize the feel and functionality of the wheeled crutch to suit the particular needs of the injury and injured user. For example, if the injured lower limb needs to be kept as straight as possible during the healing process, the front legs can be lengthened to provide a longer support area for the injured limb. If the straightness of the lower limb is not important in the recovery process, the front legs can be shortened to provide a smaller wheeled base area to allow the user to maneuver the wheeled crutch more easily. Similarly, the back legs can be lengthened to provide a sturdier, more stable wheeled base for the user. In sum, the user can tailor the dimensions and arrangement of the wheeled base to suit the user's particular needs.

Also depicted in FIGS. 1 and 2 is an optional hand brake for the wheeled crutch. In one embodiment, the hand brake is actuated by a lever 22 attached to the wheeled crutch at a location that is easily accessible by the hand of the user 100 of the device. In the embodiment depicted in FIGS. 1 and 2, the lever actuator 22 is located underneath the seat 10. Regardless of location, when the user actuates the hand brake, the signal is transmitted internally (shown) or externally (not shown) using Bowden cables, rods, chains, hydraulic lines, or other means, to a braking mechanism located on at least one of the wheels on the wheeled crutch. In a preferred embodiment, the actuator actuates braking mechanisms on all of the wheels. Examples of braking mechanisms that can be used with the present invention include friction braking mechanisms, such as calipers and drums. The caliper or drum, when actuated, puts pressure on at least one internal (shown) or external (not shown) surface of the wheel 114, and dissipates kinetic energy, primarily by converting it into thermal energy. The specific arrangement of the brake actuator, transmission mechanism, and braking mechanism can be determined by one skilled in the art based on the disclosure herein.

In the embodiment depicted in FIGS. 1 and 2 are a lower limb support 24 and a foot rest 26 that allow the user to support the injured lower limb 104 extended frontwards, or towards the front of the user 100 of the wheeled crutch 200. In the embodiment depicted in FIGS. 1 and 2, the lower limb support 24 comprises a web, mesh, or net that is connected to both of the two front legs 16 of the wheeled crutch 200. In alternative embodiments, the lower limb support can comprise a series of straps or strips, or a singular piece of fabric, which connect the two front legs. The lower limb support is preferably made out of a soft, flexible and/or padded material in order to provide comfort to the user and allow the device to be folded easily for storage and transport, but alternatively can be made out of harder materials, which might provide improved durability. The foot rest 26 depicted in these figures comprises a strap connected between the two front legs 16 of the wheeled crutch 200, but can also comprise any similar flexible construction. Again, the foot rest can alternatively be constructed as a rigid support or a combination of rigid and flexible elements, which might provide less comfort to the user and hamper the user's ability to fold the device into a more compact unit.

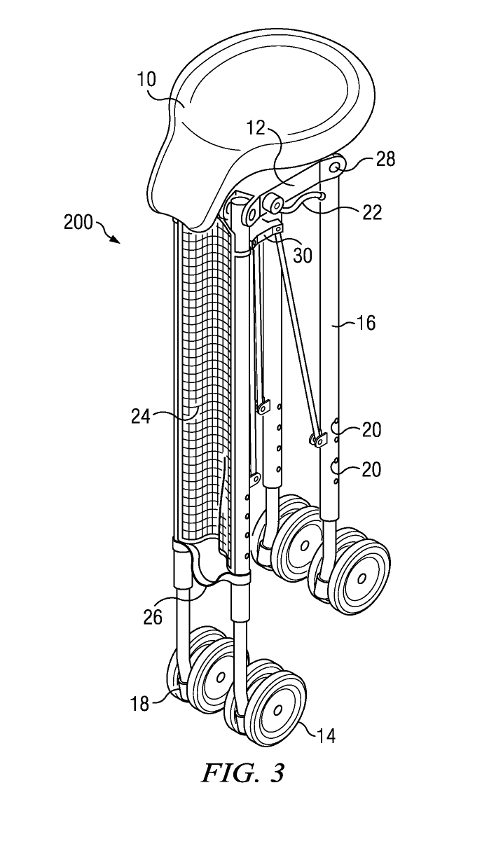

In a preferred embodiment, the wheeled crutch 200 is collapsible. In terms of the embodiments depicted in FIGS. 1 through 3, the wheeled crutch 200 is collapsible by folding the legs 16 of the crutch inward. When the wheeled crutch 200 is in the collapsed state (as depicted in FIG. 3), it can be moved and stored more easily than when the legs 16 are folded outward (as depicted in FIGS. 1 and 2). For example, the wheeled crutch 200 could be kept in the collapsed state on the sidelines during a sporting event. If a player suffers a lower limb injury during the sporting event, the wheeled crutch of the present invention could be retrieved, and its legs 16 could be quickly folded outward to allow the injured player to use it to exit the playing field.

As depicted in FIGS. 1 through 3, the each of the legs 16 of the wheeled crutch is connected to a seat support base 12 by a hinge 28 that allows the legs 16 to fold inward and outward in response to manual manipulation by the user or someone helping the user. The legs could also be attached by other moveable means, such as a ball and socket connector, or other such means known to those skilled in the art. Inward movement of the legs can be limited by contact with the other legs or contact with interior hinges, for example when all of the legs are closely grouped together, as depicted in FIG. 3. Outward movement of the legs is limited, in one embodiment, by a mechanical stop. In the preferred embodiment depicted in FIGS. 1 and 2, the mechanical stop comprises a rigid, four-way hinge 30 attached to each of the four legs. When the device is in use, the legs 16 are folded outward until the hinge 30 locks into place. To fold the legs inward, upward pressure is put on the hinge to unlock the hinge, and inward pressure is put on the legs to fold them inward. In another embodiment (not shown), each leg can have its own hinge connected to the support base that locks in place once the legs are fully folded outward. This embodiment, while it would provide sufficient rigidity to the legs when they are in the outward position, is not preferred because each leg of the wheeled crutch must be manipulated separately in order to fold the legs inward and outward. In still another embodiment (not shown), strap hinges can be used to connect opposite or adjacent legs of the wheeled crutch. Strap hinges provide easier folding and unfolding of the legs, but provide less rigidity when the legs are in the unfolded and operational position. Other types of hinges and flexible connectors can be used to give the user of the wheeled crutch the ability to fold the legs inward and outward as desired.

I claim:

1. A wheeled crutch, comprising:
a seat adapted to engage a human buttock, wherein said seat is attached to a seat support base;
at least three legs connected to said seat support base;
one wheel attached to each said leg at an end of said leg opposite said support base;
a lower limb support attached to and located between two said legs, and adapted to support a human lower limb which is extended frontward from a user of said wheeled crutch;
a foot rest attached to two said legs at an end of said lower limb support opposite said support base.

2. The wheeled crutch of claim 1 wherein said legs are each connected to said support base by a hinge.

3. The wheeled crutch of claim 1 wherein said seat is height adjustable relative to said support base.

4. The wheeled crutch of claim 1 wherein said lower limb support comprises a flexible mesh support.

5. The wheeled crutch of claim 1 wherein said foot rest comprises a flexible strap.

6. The wheeled crutch of claim 1 further comprising at least one hinge attached to said legs and adapted to restrict outward movement of said legs to a predetermined distance.

7. The wheeled crutch of claim 1 wherein said legs are length adjustable.

8. The wheeled crutch of claim 1 further comprising a hand brake.

9. The wheeled crutch of claim 1 wherein at least one said wheel can swivel.

10. The wheeled crutch of claim 1 comprising four said legs.
